(19) United States
(12) Patent Application Publication
(10) Pub. No.: US 2015/0044298 A1
(43) Pub. Date: Feb. 12, 2015

(54) DISINFECTANT COMPOSITIONS AND USES THEREOF

(71) Applicant: Robert White, Dandenong South (AU)

(72) Inventor: Robert White, Dandenong South (AU)

(73) Assignee: Robert White, Dandenong South, Victoria (AU)

(21) Appl. No.: 14/345,192

(22) PCT Filed: Sep. 17, 2012
(86) PCT No.: PCT/AU2012/001117

§ 371 Date: Mar. 14, 2014

(30) Foreign Application Priority Data
Sep. 16, 2011 (AU) PCT/AU2012/001117

(51) Int. Cl. A01N 25/24; A01N 59/16

(52) U.S. Cl. CPC A01N 25/24; A01N 59/16
USPC 424/618

(57) ABSTRACT

The present invention relates generally to disinfectant compositions comprising silver ion water and aloe vera, and methods for their use and preparation thereof. The disinfectant of the present invention possesses useful surface disinfectant qualities against potentially harmful bacteria, algae, fungi, and/or viruses.

### FIELD

The present invention relates generally to disinfectant compositions and methods for their use and preparation thereof. In particular, the invention relates to chemical compositions with useful surface disinfectant qualities against potentially harmful bacteria, algae, fungi, and/or viruses.

### BACKGROUND

Staphylococcus aureus is a facultative anaerobic gram-positive coccal bacterium. It is the most common species of Staphylococci to cause “Staph” infections. The primary reason for this is that the careotenoid pigment staphloxanthin (responsible for its generic name “golden staph”) acts as a virulence factor, having an antioxidant action which aids in the microbes evasion of death by the reactive oxygen species used by a host species immune system.

Staphylococcus aureus can cause a range of illnesses from minor skin infections to life-threatening diseases such as pneumonia, meningitis, osteomyelitis, endocarditis, toxic shock syndrome, bacteremia, and sepsis. This typically results from skin, soft tissue, respiratory, bone, joint, endovascular to wound infections. It is one of the five most common causes of nosocomial infections, often causing postsurgical wound infections. Each year, over a million patients in first-world hospitals contract a staphylococcal infection.

Methicillin-resistant Staphylococcus aureus (‘MRSA’) is one of a number of virulent strains of Staphylococcus aureus which have become resistant to most antibiotics. MRSA strains are most often found associated with medical institutions such as hospitals, but are becoming increasingly prevalent in community-acquired infections, such as in consumable meat and poultry products.

The spread of Staphylococcus aureus (including MRSA) is generally thought to be through human-to-human contact. Emphasis on basic hand washing techniques can go some of the way in preventing its transmission. The use of disposable aprons and gloves by staff reduces skin-to-skin contact and, therefore, further reduces the risk of transmission. It is thought that the pathogen's transportation in medical facilities is mainly the results of insufficient, healthcare worker hygiene. For instance, the bacteria may be transported on the hands of healthcare workers many of whom pick up the bacteria from seemingly healthy patients carrying a benign or commensal strain of Staphylococcus aureus, or from contaminated surfaces which is then passed on to the next patient being treated.

Staphylococcus aureus is an incredibly hardy bacterium, as was shown in a study where it survived on polyester for just under three months. Ethanol and isopropanol have proven to be effective immediate disinfectants against MRSA. However ethanol as a sanitizer or disinfectant can be quite transient due to its relatively high vapour pressure. Also, being flammable, it is not desirable to keep large amounts of ethanol in storage. Furthermore, alcohols do not provide effective residual or persistent disinfectant activity.

The minimisation or prevention of nosocmial infections involves routine and terminal cleaning. It is a current need to provide disinfectant compositions which are less volatile and have longer duration (increased persistence time/residual effect).

### SUMMARY OF INVENTION

In one aspect the invention provides a disinfectant composition comprising an effective amount of silver ion water and aloe vera juice or gel.

In an embodiment the disinfectant composition is in the form of a sprayable liquid.

In an embodiment the disinfectant composition is present in a disinfectant wipe.

In a further aspect the invention provides a method of disinfecting a substrate surface comprising applying to said surface a disinfectant composition comprising an effective amount of silver ion water and aloe vera juice or gel.

In an embodiment the method is conducted for the purpose of disinfecting a surface against a bacteria, algae, fungi, and/or virus.

In an embodiment the bacteria, algae, fungi, and/or virus is selected from the group consisting of Staphylococcus aureus (including MRSA), Escherichia coli (E. Coli), Pseudomonas, Proteus vulgaris, Salmonella choleraesuis, Clostridium difficile, and Enterococcus (including Vancomycin—resistant enterococei (VRE)).

In an embodiment the method is conducted for the purpose of disinfecting a surface against a bacteria, and in particular Staphylococcus aureus or MRSA.

### DESCRIPTION OF PREFERRED EMBODIMENTS

As used herein the term “disinfectant” refers to a substance that is applied to a non-living/non-biological object (and in particular, a substrate surface) to destroy microorganisms or viruses that may be present on the object. In the context of the present invention the substance is a composition which comprises silver ion water and aloe vera juice or gel. It will be appreciated that in the context of the present invention the term “disinfectant” may also encompass the concept of sanitization, as the compositions of the present invention may also serve to disinfect and clean. Without being bound to any particular mode of action the compositions of the present invention may also, in some embodiments, be classed as biocides in the context of being able to destroy viruses, in addition to microorganism such as bacteria. In relation to this latter embodiment the compositions may be thought as antibacterial disinfectants.

It will be appreciated that an “effective amount” as used herein refers to an amount of the composition which is applied to a surface to disinfect the surface against viruses (ex vivo), bacteria, algae, or fungi. Disinfection is readily achieved where the number of microorganisms killed is a Log reduction of at least 4.0 which means that less than 1 microorganism in 10,000 remains. The compositions of the present invention may provide Log reductions of at least 4.0, preferably at least 5.0, and more preferably at least about 6.0.

“Silver ion water” as used herein refers to an aqueous solution of silver ions which is formed by disposing a silver rod electrode into an aqueous medium (typically just water) and applying a voltage to the electrode rod and electrolysing. Apparatus for generating silver ion water are known and are described for instance, in WO 2006/115333.

In a preferred embodiment the concentration of silver ions (Ag⁺) in the water is about 0.02-30 ppm, such as about 0.03-20 ppm, about 0.04-10 ppm, about 0.04-2 ppm, about 0.04-1 ppm, about 0.04-0.8 ppm, about 0.04-0.50 ppm, about 0.04-0.2 ppm, about 0.04-0.1 ppm, and about 0.1 ppm.

The silver ion water typically constitutes from about 60-90% wt/wt of the total disinfectant composition. For instance, in certain embodiments the silver ion water constitutes from about 70-90% wt/wt, about 75-85% wt/wt and preferably about 80-85% wt/wt of the total disinfectant composition.

As used herein the term “aloe vera juice or gel” refers to an aloe vera liquid extract derived from the leaf of an Aloe plant and typically, Aloe barbadensis or Aloe aborescens. Most often the extracts are derived from the inner colourless parenchyma containing the aloe gel, often referred to as the “inner pulp”, “mucilage tissue”, “mucilaginous gel”, “mucilaginous jelly”, inner gel or leaf parenchyma tissue. Typically reference to “gel” or “mucilage” refers to the clear viscous liquid within the parenchyma cells. Aloe vera juice or gel is readily available commercially. For instance, a 99.9% Aloe Vera Juice comprising stabilizers is available from Aloe Vera of Australia (http://www.aloevera.com.au).

The aloe vera juice or gel typically constitutes from about 5-20% wt/wt of the total disinfectant composition. For instance, in some embodiments the aloe vera juice or gel constitutes from about 7-15% wt/wt, about 9-13% wt/wt, about 10-13% wt/wt or about 12% wt/wt of the total disinfectant composition.

Aloe vera gel typically has a viscosity (measured at 25° C.) of from about 80,000-900,000 cps, for instance, about 90,000-800,000 cps or about 100,000-700,000 cps. Aloe vera juice is typically characterised with a viscosity (measured at 25° C.) of from about 7 to 100 cps.

In an embodiment the disinfectant composition comprises about 80-85% wt/wt of silver ion water and from about 10-13% wt/wt of aloe vera juice or gel.

In a particular embodiment the composition comprises silver ion water and aloe vera juice.

In another embodiment the composition comprises silver ion water with a Ag⁺ concentration of 0.04-10 ppm, and preferably 0.04-2 ppm, and aloe vera juice.

In another embodiment the composition comprises silver ion water with a Ag⁺ concentration of 0.04-10 ppm, and preferably 0.04-2 ppm, in an amount of 60-90% wt/wt of the total disinfectant composition and aloe vera juice.

In another embodiment the composition comprises silver ion water with a Ag⁺ concentration of 0.04-10 ppm, and preferably 0.04-0.2 ppm, in an amount of 60-90% wt/wt of the total disinfectant composition and aloe vera juice in an amount of 5-20% wt/wt of the total disinfectant composition.

The disinfectant composition of the present invention may include additional ingredients such as acids (e.g., hydrochloric acid, sulphuric acid, etc); bases (e.g., sodium hydroxide, sodium carbonate, etc); surfactants (e.g., labs acid/laurylbenzene sulfonic acid, CTAB, cocodiethanolamide (CDE, or CD80), SLES or sodium laureth sulfate, soap noodles, glycols, etc); other disinfecting agents (e.g., formaldehyde (or other aldehydes), ethanol or isopropyl alcohol (or other alcohols), sodium hypochlorite (or other hypochlorites), glycols, chloroamine, hydrogen peroxide, chlorine dioxide, permanganates, peracetic acid, performic acid, phenol (and other phenolics), and quartenary ammonium compounds such as benzalkonium chloride, etc); fragrances; antioxidants; phosphates (e.g., sodium tripolyphosphate (STPP)) and colouring agents.

In an embodiment the compositions of the present invention are phosphate free.

In an embodiment the compositions of the present invention are chlorine free. That is, the compositions of the invention do not include sodium hypochlorite (or other hypochlorites), chloroamine, chlorine dioxide, and the like.

In an embodiment the composition is phosphate free and chlorine free.

In an embodiment any additional components in the specification do not constitute more than 15% wt/wt, of the total disinfectant composition. Typically, when present, the additional components comprise between about 540% wt/wt of the total disinfectant composition.

In an embodiment the pH of the disinfectant composition is 8-11, more preferably 9-11, and most preferably about 10.

In an embodiment the disinfectant composition is in the form of a sprayable liquid which may be applied to a substrate by way of a hand-actuated or pressurised spray delivery device (e.g., spray gun). In this regard, it is preferable that the viscosity of the composition in the form of a sprayable liquid is from 1 to 5 cps (measured at 25° C.).

In another embodiment the disinfectant composition may be first absorbed by an applicator device (e.g., mob, cloth, cotton bud, paint brush, etc) and applied to a substrate.

In an embodiment the disinfectant composition is provided in the form of a disinfectant wipe.

The wipe may improve the compositions performance by providing mechanical/physical cleaning properties. The wipes of the invention comprise an absorbent substrate, for instance, an absorbent nonwoven water insoluble substrate, which has been impregnated with the disinfectant composition. The wipe may take the form of a towellette, cloth, sheet, pad, or sponge and may also be associated with a holder device or applicator device such as a handle. The impregnation step involves contacting the wipe with the composition, for instance, by spraying or immersing the wipe with the composition for a time and under conditions sufficient to allow for the wipe to be impregnated with the composition.

In an embodiment the wipe is a nonwoven water insoluble material (substrate) which is synthetic or of plant origin. Such materials include rayon, polyester, nylon, polyethylene, cotton, or cardboard.

The substrate for the wipes may be impregnated with the disinfecting composition at the loading level from about 1.5 times the original weight of the wipe to about 10 times the original weight of the wipe, preferably from about 2.5 times to about 7.5 times, and more preferably from about 3 times to about 6 times.

The composition of the present invention may be applied to any substrate which may come into contact with a microorganism or virus, such as in a hospital setting. Accordingly, contemplated substrates include plastics/polymer surfaces (e.g., polyesters, PVC, etc), stainless steel, wood, glass, laminates, ceramic, and so on.

In relation to the disinfectant qualities the present composition may be suitable for disinfecting a surface against the following: methicillin resistant staphylococcus aureus (including MRSA), staphylococcus aureus, human coronavirus, influenza A, listeria monocytogenus, herpes simplex virus type 1, escherichia coli (E. coli), acinetobacter baumannii, vancomycin resistant enterococcus faecium (VRE), bacillus cereus, klebsiella pneumoniae, rotavirus, human immunodeficient virus type 1, pseudomonas aeruginosa, norovirus, salmonella choteraesuis, Clostridium difficile, rhinovirus, and trichophyton mentagrophytes (Athlete's foot fungi).

In an embodiment the bacteria, algae, fungi, and/or virus is selected from the group consisting of Staphylococcus aureus (including MRSA), Escherichia coli (E. Coli), Pseudomonas, Proteus vulgaris, Salmonella choleraesuis, Clostridium difficile, and Enterococcus (including Vancomycin—resistant enterococci (VRE)).

Preferably the disinfectant qualities of the composition are suitable for disinfecting a surface against a gram-positive bacteria, preferably clostridium, Enterococcus, or Staphylococcus.

Preferably the disinfectant qualities of the composition are suitable for disinfecting a surface against a gram-negative bacteria, preferably Escherichia, Pseudomonas, Proteus vulgaris, and Salmonella.

Preferably the disinfectant qualities of the composition are suitable for disinfecting a surface against a bacteria, and preferably staphylococcus aureus and MRSA.

The antibacterial and antimicrobial nature of the silver ion (Ag⁺) has been previously reported. It is thought that when silver ions come into contact with a microbe they bind to the cell membrane proteins' active site via thio groups. This in turn appears to cause a malfunctioning of the membrane (and membrane production) allowing more silver ions to penetrate the microbe which eventually dies due to cell lysis and/or cessation of metabolic functioning of membrane proteins.

Without wishing to be bound by theory it is believed that the aloe vera juice or gel enhances the persistence or residence time of this action on the surface by acting as a carrier and delivery system for the active silver ions. Tests performed by the present inventor suggest that the relatively hydrophobic nature of some of the components (possibly polymer components) in the aloe vera juice or gel aids in the composition's ability to adhere and persist on a substrate surface even after being washed with water. This is thought to facilitate increased microbe/Ag⁺ interaction which is beneficial in terms of a longer lasting disinfectant effect. For instance, the residual efficacy of the disinfectant qualities of the present invention could be as long as 2 to 5 days. In surgical suites it is typically mandatory to disinfect after each surgical procedure. Due to human error it is not always the case that an acceptable microbe free environment can be maintained between surgical procedures. With a longer lasting persistence time the chances of not having a microbe free surface between procedures is reduced. That is, if a surface is initially disinfected but due to human error is not re-disinfected for 24-48 hours, the chances of this surface harbouring concerning levels of dangerous microbes will be reduced with the present composition. Thus while also being beneficial in terms of maintaining a significantly longer lasting microbe free surface, the present compositions may also be beneficial in terms of minimising the continued need to disinfect and re-disinfect a surface. For instance, with traditional disinfectants it is often necessary to disinfect everyday to maintain an effectively clean (i.e., microbe free) surface. By using the present composition a microbe free (or substantially microbe free) environment could be accomplished with disinfecting every other day.

As a further advantage it is believed that the aloe vera, while acting as a carrier to maintain Ag⁺ concentration on a surface for longer, may also provide an additive or synergistic antibacterial effect. For instance, it has been reported that some of the constituents of aloe vera juice or gel including lupeol, cinnamic acid, phenols (e.g., anthraquinones), and saponins, may provide antimicrobial benefits.

In an embodiment the composition provides a Log reduction of at least 4.0 for 24-48 hrs.

In an embodiment the composition provides a Log reduction of at least 4.0 for about 48 hrs.

In an embodiment the composition provides a Log reduction of at least 4.0 for about 48-72 hrs.

In another embodiment the composition provides a Log reduction of at least 4.0 for 24-72 hrs.

In a further embodiment the composition provides a Log reduction of at least 4.0 for 24-96 hrs.

In a further embodiment the composition provides a Log reduction of at least 4.0 for 24-120 hrs.

Those skilled in the art will appreciate that the invention described herein in susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

The reference in this specification to any prior publication (or information derived from it), or to any matter which is known, is not, and should not be taken as an acknowledgment or, admission or any form of suggestion that that prior publication (or information derived from it) or known matter forms part of the common general knowledge in the field of endeavour to which this specification relates.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Certain embodiments of the invention will now be described with reference to the following examples which are intended for the purpose of illustration only and are not intended to limit the scope of the generality hereinbefore described.

### EXAMPLES

### 1. Disinfectant Compositions

a) Phosphate Based Formulation

| Material Name | Amount | |
|---|---|---|
| Silver Ion Water (0.1 ppm) | 815.32 | L |
| Sodium Hydroxide | 1.07 | Kg |
| STPP, Sodium Tripolyphosphate | 18.02 | Kg |
| Sodium Carbonate, Dense Soda Ash | 9.01 | Kg |
| Labs Acid | 8.11 | Kg |
| CDE 80, Decolamide, Coco | 0.52 | Kg |
| Diethanolamine | | |
| SLES, Chemsalan, Genapol LRO Paste | 2.10 | Kg |
| Butyl Di Glycol S.G. 95 | 27.03 | Kg |
| Formaldehyde | 2.00 | Kg |
| Rhodomine ACID Dye | 0.90 | g |
| Fragrance Rain Forest | 0.90 | Kg |
| Aloe Vera Juice | 99.10 | Kg |
| Water Hot | 9.01 | L |
| Soap Noodles | 1.25 | Kg |

b) Phosphate-Free Formulation

| Material Name | Amount | |
|---|---|---|
| Silver Ion Water (0.1 ppm) | 815.32 | L |
| Sodium Hydroxide | 1.07 | Kg |
| Sodium Carbonate, Dense Soda Ash | 9.01 | Kg |
| Labs Acid | 8.11 | Kg |
| CDE 80, Decolamide, Coco | 0.52 | Kg |
| Diethanolamine | | |
| SLES, Chemsalan, Genapol LRO Paste | 2.10 | Kg |
| Butyl Di Glycol S.G. 95 | 27.03 | Kg |
| Formaldehyde | 2.00 | Kg |
| Rhodomine ACID Dye | 0.90 | g |
| Fragrance Rain Forest | 0.90 | Kg |
| Aloe Vera Juice | 99.10 | Kg |
| Water Hot | 9.01 | L |
| Soap Noodles | 1.25 | Kg |

### General Formulation Methodology for Formulations a) or b)

SILVER ION WATER is added to a tank. While mixing, SODIUM HYDROXIDE, STPP (optional) and SODIUM CARBONATE are added and mixed until dissolved. While still mixing, LABS ACID and CDE are added, SLES and BUTYL DIGLYCOL are premixed and then also added to the tank. FORMALDEHYDE, DYE, and LITSEA CUBEBA (fragrance) are then also added to the tank. SOAP NOODLES are dissolved in 1 litre of HOT WATER (as hot as possible) and added to the tank and mixed. The ALOE VERA JUICE is then added. The pH of the formulation is 10.

### 2. Disinfectant Testing—Substrate Based

### a) General Method

The antimicrobial activity of composition 1a was tested using the JIS methodology JIS Z 2801:2000(E) conducted by Micromon (Monash University)—Melbourne Australia (ABN 12377614012)

Provided was three test pieces and six control pieces of a substrate 50 mm×50 mm.

According to the standard, each control and test piece for all three samples were cleaned by wiping lightly with 80% ethanol and then placed in individual sterile Petri dishes. Composition 1a was then applied to three test pieces. For analysis of the immediate effect of 1a, each test piece and six control pieces were then inoculated with 0.4 mL of a culture of Staphylococcus aureus ATCC6538 that had been adjusted by dilution to approximately 2.5×10⁵ cells per mL.

The inoculum was covered with a film measuring 40×40 mm and the film pressed to spread the inoculum over the entire surface area of the sample covered by the film. The lid was then placed on the Petri dish. The Petri dishes containing three control pieces and three test pieces for each sample were then incubated at 35° C. (relative humidity of approximately 90%) for 24 hours. The three remaining Petri dishes containing control pieces from each sample were processed immediately to determine the base line viable count.

To test the viable number of bacterial cells present from each of the control pieces, both prior to and following incubation, and the test pieces, 10 ml of SCDLP broth was added to the Petri dishes containing the pieces, and the Petri dish was then shaken for 10 minutes on an orbital shaker. Following this, 1 mL of the washings was taken from each test and control piece and diluted in sterile physiological saline. One mL aliquots of various dilutions were added to duplicate 15 mL of molten plate count agar and mixed thoroughly. The plate count agar was then poured into sterile Petri dishes and allowed to set. Plates were then incubated at 35° C. (relative humidity of approximately 90%) for 40 hours. Following incubation the number of colonies present on each plate were recorded and a viable count calculated.

### b) Results

### 1. On Laminate

The results recorded from these plates are given in the tables below:

TABLE 1
Viable Counts for samples when Staphylococcus aureus was used as an
inoculum

Viable Count (cfu/ml)

| | Composition 1a | Composition 1a |
|---|---|---|
| | Cleaner T₀ | Cleaner T₂₄ |
| Prior to Incubation: | | |
| Control 1 | 1.41 × 10⁷ | 4.10 × 106 |
| Control 2 | 1.52 × 10⁷ | 2.65 × 106 |
| Control 3 | 1.46 × 10⁷ | 4.50 × 106 |
| Post Incubation: | | |
| Control 4 | 1.14 × 10⁶ | 5.00 × 102 |
| Control 5 | 3.02 × 10⁶ | 1.17 × 103 |
| Control 6 | 1.50 × 10⁶ | 5.65 × 105 |
| Post Incubation: | | |
| Test 1 | <10 | <10 |
| Test 2 | <10 | <10 |
| Test 3 | 55 | <10 |

An average of the viable counts for the three controls were taken prior to incubation, the three controls post incubation, and the three test pieces for each of the samples.

This data is presented in the tables below:

TABLE 2
Average viable counts for pre and post incubation controls and test
pieces when Staphylococcus aureus was used as an inoculum.

Average Viable Count (cfu/ml)

| | Composition 1a | Composition 1a |
|---|---|---|
| | Cleaner T₀ | Cleaner T₂₄ |
| Prior to Incubation | | |
| Untreated Controls | 1.46 × 10⁶ | 3.75 × 106 |
| Post Incubation: | | |
| Untreated Controls | 1.89 × 10⁶ | 1.89 × 105 |
| Post Incubation: | | |
| Treated Test Pieces | 25 | 10 |

The efficiency of each of the tests was determined using the following formula based on the results reported in the above-tables:

(Lₘₐₓ−Lₘᵢₙ)/(Lₘₑₐₙ)≦0.2

### Where:

Lₘₐₓ: maximum logarithm of the number of viable cells of bacteria immediately following inoculation on untreated test pieces.
Lₘᵢₙ: minimum logarithm of the number of viable cells of bacteria immediately following inoculation on untreated test pieces.
Lₘₑₐₙ: average logarithm of the number of viable cells of bacteria immediately following inoculation on untreated test pieces.

The test was judged as being effective when the above equation was satisfied.

Logarithmic values of the number of viable cells of bacteria immediately following inoculation on the untreated test pieces are reported in the tables below:

TABLE 3
Logarithms for untreated samples following inoculation when
Staphylococcus aureus was used as an inoculum

Logarithmic value of viable cells

| | Composition 1a | Composition 1a |
|---|---|---|
| | Cleaner T₀ | Cleaner T₂₄ |
| Prior to Incubation: | | |
| Control 1 | 7015 (Lₘᵢₙ) | 6.61 |
| Control 2 | 7.18 (Lₘₐₓ) | 6.42 (Lₘᵢₙ) |
| Control 3 | 7.16 | 6.65 (Lₘₐₓ) |
| Lₘₑₐₙ | 7.16 | 6.56 |
| (Lₘₐₓ − Lₘᵢₙ)/(Lₘₑₐₙ) | 0.003 | 0.035 |

Based on the above data all tests were determined to be effective as the equation was satisfied in each instance.

The value of the antimicrobial activity was then calculated for each test using the following equation:

R=[log(B/A)−log(C/A)]=[log(B/C)]

### Where:

R: value of antimicrobial activity
A: average of the number of viable cells of bacteria immediately after inoculation on the untreated test pieces
B: average of the number of viable cells of bacteria on the untreated test piece after 24 hours
C: average of the number of viable cells of bacteria on the treated test piece after 24 hours

Higher numbers for the value of R indicate better antimicrobial activity. The values of R, A, B and C are recorded in the following tables:

TABLE 4
Values of R, A, B and C when Staphylococcus aureus was used as an
inoculum

Average Viable Count (cfu/ml)

| | Composition 1a | Composition 1a |
|---|---|---|
| | Cleaner T₀ | Cleaner T₂₄ |
| Prior to Incubation | | |
| Untreated Controls | 1.46 × 10⁶ | 3.75 × 10⁶ |
| [A] | | |
| Post Incubation: | | |
| Untreated Controls | 1.89 × 10⁶ | 1.89 × 10⁵ |
| [B] | | |
| Post Incubation: | | |
| Treated Test Pieces | 25 | 10 |
| [C] | | |
| Antimicrobial | 4.9 | 4.3 |
| Activity [R] | | |
| % Reduction | >99.99% | >99.99% |
| | (>4.0 log₁₀) | (>4.0 log₁₀) |

### Comments:

The tests conducted were deemed to be effective as dictated by standard JIS Z 2801:2000(E).

As is indicated by the positive values for Antimicrobial Activity [R] the product, 1a, has significant antimicrobial activity against Staphylococcus aureus when tested on laminate. This level of activity (>3 for Antimicrobial Activity, and >99.9% for the % Reduction) is categorized as strong activity. Further, this level of activity was retained even when the product had been applied 24 hours previous to the challenge with the bacteria.

### 2. On Stainless Steel

The results recorded from these plates are given in the tables below:

TABLE 5
Viable Counts for samples when Staphylococcus aureus was used as an
inoculum

Viable Count (cfu/ml)

| | Composition 1a | Composition 1a |
|---|---|---|
| | Cleaner T₀ | Cleaner T₂₄ |
| Prior to Incubation: | | |
| Control 1 | 1.32 × 10⁶ | 4.30 × 10⁶ |
| Control 2 | 1.94 × 10⁶ | 4.90 × 10⁶ |
| Control 3 | 1.39 × 10⁶ | 4.70 × 10⁶ |
| Post Incubation: | | |
| Control 4 | 7.00 × 10⁶ | 5.45 × 10⁶ |
| Control 5 | 5.95 × 10⁵ | 7.65 × 10⁶ |
| Control 6 | 1.04 × 10⁵ | 9.95 × 10⁶ |
| Post Incubation: | | |
| Test 1 | 8.15 × 10⁵ | 1.99 × 10⁶ |
| Test 2 | <10 | 2.29 × 10⁶ |
| Test 3 | 7.35 × 10² | 1.48 × 10⁶ |

We then took an average of the viable counts for the three controls prior to incubation, the three controls post incubation, and the three test pieces for each of the samples.

This data is presented in the tables below:

TABLE 6
Average viable counts for pre and post incubation controls and test
pieces when Staphylococcus aureus was used as an inoculum

Average Viable Count (cfu/ml)

| | Composition 1a | Composition 1a |
|---|---|---|
| | Cleaner T₀ | Cleaner T₂₄ |
| Prior to Incubation | | |
| Untreated Controls | 1.55 × 10⁶ | 4.63 × 106 |
| Post Incubation: | | |
| Untreated Controls | 2.57 × 10⁶ | 7.68 × 106 |
| Post Incubation: | | |
| Treated Test Pieces | 232 × 10⁵ | 1.92 × 106 |

The efficiency of each of the tests was determined using the following formula based on the results reported in the above tables:

(Lₘₐₓ−Lₘᵢₙ)/(Lₘₑₐₙ)≦0.2

### Where:

Lₘₐₓ: maximum logarithm of the number of viable cells of bacteria immediately following inoculation on untreated test pieces.
Lₘᵢₙ: minimum logarithm of the number of viable cells of bacteria immediately following inoculation on untreated test pieces.
Lₘₑₐₙ: average logarithm of the number of viable cells of bacteria immediately following inoculation on untreated test pieces.

The test was judged as being effective when the above equation was satisfied.

Logarithmic values of the number of viable cells of bacteria immediately following inoculation on the untreated test pieces are reported in the tables below:

TABLE 7
Logarithms for untreated samples following inoculation when S. aureus
was used as an inoculum

Logarithmic value of viable cells

| | Composition 1a | Composition 1a |
|---|---|---|
| | Cleaner T₀ | Cleaner T₂₄ |
| Prior to Incubation: | | |
| Control 1 | 6.12 (Lₘᵢₙ) | 6.63 (Lₘᵢₙ) |
| Control 2 | 6.29 (Lₘₐₓ) | 6.69 (Lₘₐₓ) |
| Control 3 | 6.14 | 6.67 |
| Lₘₑₐₙ | 6.18 | 6.66 |
| (Lₘₐₓ − Lₘᵢₙ)/(Lₘₑₐₙ) | 0.03 | 0.009 |

Based on the above data all tests were determined to be effective as the equation was satisfied in each instance.

The value of the antimicrobial activity was then calculated for each test using the following equation:

R=[(log(B/A)−log(C/A)]=[log(B/C)]

### Where:

R: value of antimicrobial activity
A: average of the number of viable cells of bacteria immediately after inoculation on the untreated test pieces
B: average of the number of viable cells of bacteria on the untreated test piece after 24 hours
C: average of the number of viable cells of bacteria on the treated test piece after 24 hours

Higher numbers for the value of R indicate better antimicrobial activity. The values of R, A, B and C are recorded in the following tables:

TABLE 8
Values of R, A, B and C when Staphylococcus. aureus was used as an
inoculum

Average Viable Count (cfu/ml)

| | Composition 1a | Composition 1a |
|---|---|---|
| | Cleaner T₀ | Cleaner T₂₄ |
| Prior to Incubation | | |
| Untreated Controls | 1.55 × 10⁶ | 4.63 × 106 |
| [A] | | |
| Post Incubation: | | |
| Untreated Controls | 2.57 × 10⁶ | 7.68 × 106 |
| [B] | | |
| Post Incubation: | | |
| Treated Test Pieces | 2.72 × 10⁵ | 1.92 × 106 |
| [C] | | |
| Antimicrobial | 0.97 | 0.60 |
| Activity [R] | | |
| % Reduction | 89.42% | 75.00% |

### Comments:

The tests conducted were deemed to be effective as dictated by standard HS Z 2801:2000(E).

As is indicated by the positive values for Antimicrobial Activity [R] the product, 1a, has some level of antimicrobial activity against Staphylococcus aureus when tested on stainless steel.

It is worth noting that the product, when applied to stainless steel produces a surfactant-like quality, which makes it difficult to retain the bacterial test sample on the surface of the test piece. The activity reported here may in actual fact be much more significant, as it is possible that the bacteria were able to escape killing because they may have “slipped” off the test piece during the 24 incubation step,

The claims defining the invention are as follows:

1. A disinfectant composition comprising an effective amount of silver ion water and aloe vera juice or gel.

2. A disinfectant composition comprising an effective amount of silver ion water and aloe vera juice or gel, wherein the disinfectant composition is in the form of a sprayable liquid.

3. A disinfecting composition comprising an effective amount of silver ion water and aloe vera juice or gel, wherein the disinfectant composition is impregnated into a wipe.

4. A disinfectant composition according to any one of claims 1 to 3 wherein the composition comprises silver ion water with a Ag⁺ concentration of about 0.04-10 ppm, preferably about 0.04-2 ppm or about 0.04-1 ppm or about 0.04-0.08 ppm.

5. A disinfectant composition according to any one of claims 1 to 4 wherein the composition comprises silver ion water from about 60-90% wt/wt of the total disinfectant composition.

6. A disinfectant composition according to any one of claims 1 to 5 wherein the composition comprises aloe vera juice or gel from about 5-20% wt/wt of the total disinfectant composition.

7. A disinfectant composition according to any one of claims 1 to 5 wherein the composition comprises aloe vera juice or gel from about 7-15% wt/wt of the total disinfectant composition.

8. A disinfectant composition according to any one of claims 1 to 3 wherein the composition comprises a concentration of silver ion (Ag⁺) from about 0.04-2 ppm, and aloe vera juice or gel from 5-20% wt/wt of the total disinfectant composition, and wherein the silver ion water constitutes 60-90% wt/wt of the total disinfectant composition.

9. A disinfectant composition according to any one of claims 1 to 8 wherein the composition is phosphate free.

10. A disinfectant composition according to any one of claims 1 to 8 wherein the composition is chloride free.

11. A disinfectant composition according to any one of claims 1 to 8 wherein the composition is phosphate and chloride free.

12. A disinfectant composition according to any one of claims 1 to 11 comprising Aloe Vera juice.

13. A disinfectant composition according to any one of claims 1 to 12 wherein the pH of the composition is about 9-11.

14. A disinfectant composition according to claim 13 wherein the pH of the composition is about 10.

15. A method of disinfecting a substrate surface comprising applying to said surface (non-biological) a disinfectant composition according to any one of claims 1 to 14.

16. A method according, to claim 15 for disinfecting a surface against a bacteria, algae, fungi, and/or virus selected from the group consisting of Staphylococcus aureus (including MRSA), Escherichia coli (E. Coli), Pseudomonas, Proteus vulgaris, Salmonella choleraesuis, Clostridium difficile, and Enterococcus (including Vancomycin—resistant enterococci (VRE)).

17. A method according to claim 16 for disinfecting a surface against a bacteria, and preferably Staphylococcus aureus or MRSA.

18. A method according to claim 16 for disinfecting a surface against E. Coli.

19. A method according to claim 16 for disinfecting a surface against Pseudomonas.

20. A method according to claim 16 for disinfecting a surface against Proteus vulgaris.

21. A method according to claim 16 for disinfecting a surface against Salmonella choleraesuis.

22. A method according to claim 16 for disinfecting a surface against Clostridium difficile.

23. A method according to claim 16 for disinfecting a surface against VRE.

24. A method according to any one of claims 15 to 23 wherein the substrate is selected from the group consisting of plastics/polymers, stainless steel, wool, glass, laminates and ceramics.

25. A method according to any one of claims 15 to 17 wherein the composition provides a Log reduction of at least 4.0 for about 48-72 hrs in relation to Staphylococcus aureus or MRSA.
